(19) United States
(12) Patent Application Publication
(10) Pub. No.: US 2011/0183684 A1
(43) Pub. Date: Jul. 28, 2011

(54) MOBILE COMMUNICATION TERMINAL AND METHOD

(75) Inventors: Sang-Myoung KIM, Seoul (KR); Si-Deog KIM, Seongnam-si (KR); Jin-Woo YANG, Bucheon-si (KR); Young-Min LEE, Siheung-si (KR); Jin-Ho JEONG, Seoul (KR)

(73) Assignee: PANTECH CO., LTD., Seoul (KR)

(21) Appl. No.: 12/874,595

(22) Filed: Sep. 2, 2010

(30) Foreign Application Priority Data
Jan. 26, 2010 (KR) 10-2010-0006994

(51) Int. Cl. H04W 24/00; H04M 1/00

(52) U.S. Cl. 455/456.1; 455/556.1

(57) ABSTRACT

A mobile communication terminal and a method are employed to select an object in an image captured by a camera, to detect information about a current position of the mobile communication terminal, information about a bearing of the object, and information about the distance between the current position of the mobile communication terminal and the object, and to calculate the position of the object based on the information. Thus, information about an object located a distance from the current position of the mobile communication terminal can be obtained using the mobile communication terminal.

### CROSS-REFERENCE TO RELATED APPLICATION

This application claims the benefit from and the benefit of a Korean Patent Application No. 10-2010-0006994, filed on Jan. 26, 2010, which is hereby incorporated by reference for all purposes.

### BACKGROUND

1. Field

The following description relates to information acquisition technology, and more particularly, to a technology for obtaining position information of an object using a mobile communication terminal.

2. Discussion of the Background

Generally, a current position of a mobile communication terminal has been determined by using a global positioning system (GPS) unit loaded on the mobile communication terminal. However, it may be useful to identify information about an object located a short distance away from the current position of the mobile communication terminal.

### SUMMARY

Exemplary embodiments of the present invention provide a mobile communication terminal capable of obtaining position information of an object and a method of obtaining information about an object by using the mobile communication terminal, the mobile communication terminal and the method being employed to obtain information about an object located a distance away from the current position of the mobile communication terminal.

Additional features of the invention will be set forth in the description which follows, and in part will be apparent from the description, or may be learned by practice of the invention.

An exemplary embodiment of the present invention discloses a mobile communication terminal including a camera to capture an image; a display unit to display the image; a position calculation unit to obtain information about a position of the mobile communication terminal; a bearing calculation unit to obtain information about a bearing of an object in the image displayed on the display unit; a distance measurement unit to measure a distance between the position of the mobile communication terminal and the object; and a control unit to select the object and to calculate a position of the object based on the information about the position of the mobile communication terminal, the information about the bearing of the object, and the measured distance between the current position of the mobile communication is terminal and the object.

An exemplary embodiment of the present invention discloses a method of obtaining information about an object using a mobile communication terminal, the method including displaying an image captured by a camera on a display unit of the mobile communication terminal; selecting an object in the displayed image; obtaining information about a position of the mobile communication terminal; obtaining information about a bearing of the object; measuring a distance between the position of the mobile communication terminal and the object; and calculating a position of the object based on the information about the position of the mobile communication terminal, the information about the bearing of the object, and the distance between the position of the mobile communication terminal and the object.

An exemplary embodiment of the present invention discloses a mobile communication terminal including a camera to capture an image including an object; a display unit to display the image; and a control unit to select the object and to calculate a position of the object based on information about a position of the mobile communication terminal, information about a bearing of the object, and a distance between the current position of the mobile communication terminal and the object.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a mobile communication terminal capable of obtaining position information of an object according to an exemplary embodiment.

FIG. 2 is a diagram illustrating a calculation of a position of an object relative to a current position of the mobile communication terminal according to an exemplary embodiment.

FIG. 3 is a flowchart illustrating a method of obtaining information about an object by using the mobile communication terminal of FIG. 1 according to an exemplary embodiment.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Descriptions of well-known functions and constructions may be omitted to increase clarity and conciseness.

The terms used in the following description are terms defined taking into consideration the present invention, and may be changed in accordance with the option of a user or operator or a usual practice. Therefore, the definitions of these terms should be determined is based on the entire content of this specification.

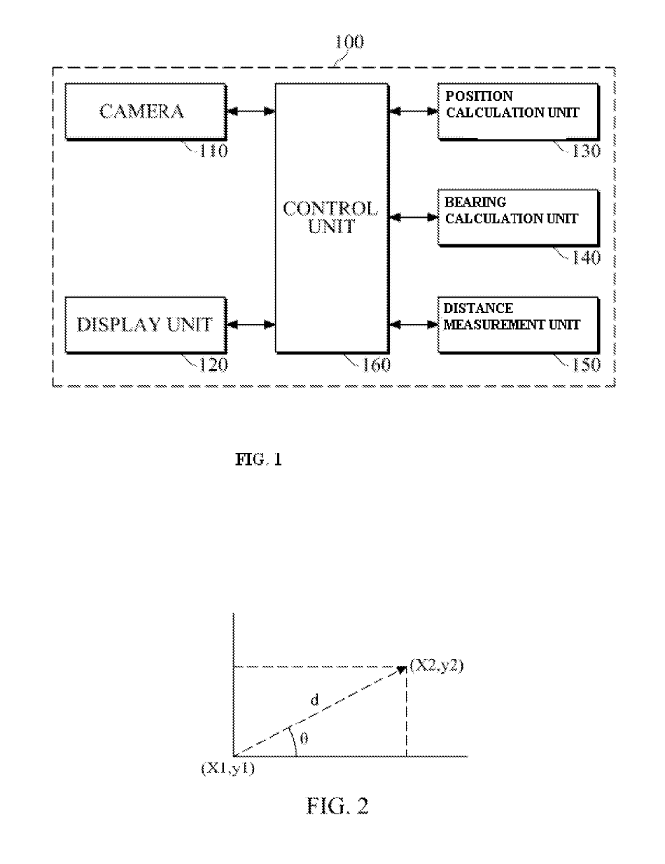

FIG. 1 is a block diagram of a mobile communication terminal 100 capable of obtaining position information of an object according to an exemplary embodiment. Referring to FIG. 1, the mobile communication terminal 100 includes a camera 110, a display unit 120, a position calculation unit 130, a bearing calculation unit 140, a distance measurement unit 150, and a control unit 160.

The camera 110 photographs or captures an image. If the mobile communication terminal 100 is in a photographing mode, the mobile communication terminal 100 may operate in a preview state in which an image is captured and displayed in real-time in a preview mode until a user presses the Confirm button to store the captured image. The image may be captured and stored as a still image or a moving image.

The display unit 120 displays an image photographed by the camera 110. If a user directs the camera 110 in the preview state to face a desired object, an image of the object and its surroundings are displayed on the display unit 120 in real-time, such as in a preview state.

The position calculation unit 130 obtains or determines information about the current position of the mobile communication terminal 100. The position calculation unit 130 may be a global positioning system (GPS) unit. Since calculating the position of the mobile communication terminal 100 using the GPS unit is known technology, a detailed description thereof will be omitted.

The bearing calculation unit 140 obtains or determines bearing information of an object contained in an image displayed on the display unit 120. Here, the bearing calculation unit 140 may calculate the bearing of the object based on information about the photographing angle of the camera 110 and information about the current position of the mobile communication terminal 100, which is obtained by the position calculation unit 130.

The bearing calculation unit 140 may be an electronic goinometer, which measures longitude; an electronic compass, which measures latitude; or a gyrosensor, which measures both longitude and latitude.

The distance measurement unit 150 measures the distance between the current position of the mobile communication terminal 100 and an object. Here, the distance measurement unit 150 may measure the distance between the current position of the mobile communication terminal 100 and the object by projecting a beam of light (e.g., an ultrasonic wave or a laser beam) onto the object and receiving the beam of light reflected by the object. If a time at which the distance measurement unit 150 projects the beam of light onto an object and a time at which the distance measurement unit 150 receives the beam of light reflected by the object are measured, the distance between the current position of the mobile communication terminal 100 and the object can be determined by Equation (1) below.

d=c(t2−t1)/2 Equation (1)

in which d is the distance between the current position of the mobile communication terminal 100 and an object, c is the propagation speed of a beam of light, t1 is a time at which the beam of light is projected onto the object, and t2 is a time at which the beam of light reflected by the object is received.

The control unit 160 selects an object and calculates the position of the object based on information about the current position of the mobile communication terminal 100, which is obtained by the position calculation unit 130; information about the bearing of the object, which is obtained by the bearing calculation unit 140; and information about the distance between the current position of the mobile communication terminal 100 and the object, which is obtained by the distance measurement unit 150.

If the display unit 120 is a touch screen, the control unit 160 may select an object in an image displayed on the touch screen by sensing a touch at a position on the touch screen corresponding to the object. Alternatively, the control unit 160 may select an object based on a focal position of an image displayed on the display unit 120.

Once the current position of the mobile communication terminal 100, the bearing of an object, and the distance between the current position of the mobile communication terminal 100 and the object are identified, the position of the object can be calculated using trigonometry.

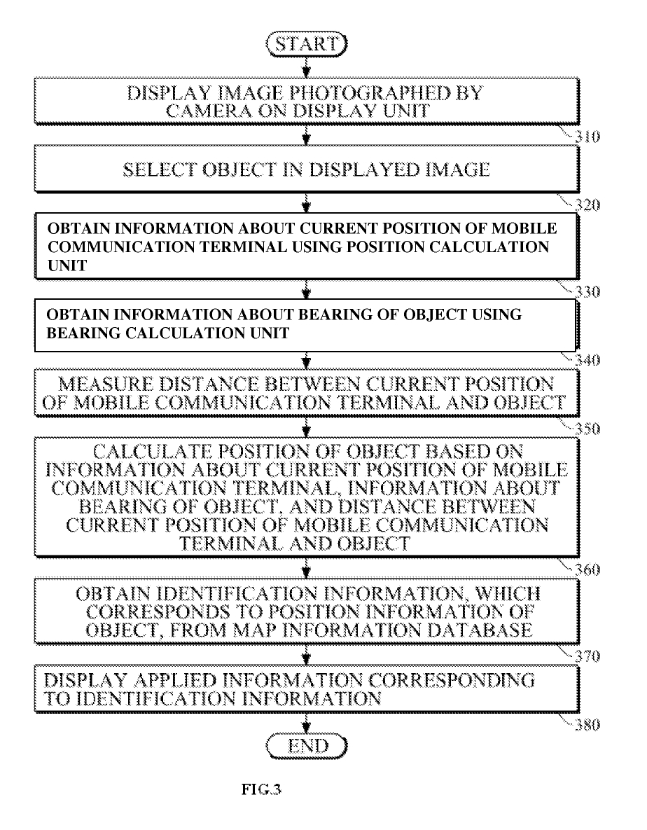

FIG. 2 is a diagram illustrating a calculation of a position of an object relative to a current position of the mobile communication terminal 100 according to an exemplary embodiment. Referring to FIG. 2, the current position of the mobile communication terminal 100 may be (x1, y1), a bearing angle to an object may be θ, and the distance between the current position of the mobile communication terminal 100 and the object may be d. In this case, the position (x2, y2) of the object may be given by Equations (2) and (3).

cos θ=(x2−x1)/d, Equation (2)

sin θ=(y2−y1)/d Equation (3)

Since Equations (2) and (3) can respectively be transposed to x2=x1+d cos θ and y2=y1+d sin θ, the position (x2, y2) of the object is (x1+d cos θ, y1+d sin θ).

An object is selected in an image photographed by the camera 110, information about the current position of the mobile communication terminal 100, information about the bearing of the object, and information about the distance between the current position of the mobile communication terminal 100 and the object are detected or determined, and the position of the object is calculated based on the information. In this way, information about an object located a distance from the current position of the mobile communication terminal 100 can be determined using the mobile communication terminal 100.

The control unit 160 may obtain identification information of an object, which corresponds to information about the calculated position of the object, from a map information database. The map information database may be stored in a built-in memory (not shown) of the mobile communication terminal 100 and may be periodically or non-periodically updated by a server (not shown). Alternatively, the map information database may be received from the server in real-time.

Identification information of an object, which corresponds to position information thereof, is recorded in the map information database of a geographic information system (GIS) (not shown). In the current example, the control unit 160 retrieves identification information of an object, which corresponds to information about the calculated position of the object, from the map information database and identifies the object based on the retrieved identification information.

The control unit 160 may control display of applied information which corresponds to identification information of an object. Examples of the applied information include navigation information regarding the object, information about facilities of the object and how to use the facilities, and advertisement information related to the object.

Identification information of an object, which corresponds to position information thereof, is stored in the map information database of the GIS. By extension, various applied information may correspond to each piece of identification information.

In the current example, the control unit 160 retrieves identification information of an object, which corresponds to information about the calculated position of the object, and applied information, which corresponds to the identification information of the object, from the map information database and controls the display unit 120 of the mobile communication terminal 100 to display the applied information which corresponds to the identification information.

Thus, a user may obtain various applied information about an object located a distance away from the current position of the mobile communication terminal 100 by using the mobile communication terminal 100. For example, the user can easily obtain navigation information including the object information about facilities of the object and how to use the facilities, or advertisement information related to the object.

The control unit 160 may control the distance measurement unit 150 to rotate to an angle and a bearing which correspond respectively to information about the photographing angle of the camera 110 and information about the bearing of an object, which are obtained or determined by the bearing calculation unit 140.

The distance measurement unit 150 may be installed on the mobile communication terminal 100 to be rotatable, and the control unit 160 may control the distance measurement unit 150 to rotate to an angle and a bearing which correspond respectively to information about the photographing angle of the camera 110 and information about the bearing of an object, which are obtained or determined by the bearing calculation unit 140.

Thus, if a desired object is selected from a plurality of objects in an image displayed on the display unit 120 of the mobile communication terminal 100 in order to find out position information of the selected object, the control unit 160 may automatically rotate the distance measurement unit 150 such that the distance measurement unit 150 can project a beam of light in the direction of the selected object.

FIG. 3 is a flowchart illustrating a method of obtaining information about an object by using the mobile communication terminal 100 of FIG. 1 according to an exemplary embodiment. Referring to FIG. 3, the mobile communication terminal 100 displays an image photographed by the camera 110 on the display unit 120 (operation 310). The mobile communication terminal 100 may be in a preview state such that the image need not be stored but may be displayed in real-time by the display unit 120.

Then, the mobile communication terminal 100 selects an object in the image which is displayed on the display unit 120 in operation 310 (operation 320).

In operation 320, the mobile communication terminal 100 may select the object in the image displayed on the display unit 120 by sensing a touch inputted to a touch screen of the mobile communication terminal 100. Alternatively, the mobile communication terminal 100 may select the object based on a focal position of the image displayed on the display unit 120, or upon another selection mechanism, such as a moveable selection icon on the display unit 120.

After selecting the object in operation 320, the mobile communication terminal 100 obtains information about the current position of the object using the position calculation unit 130 (operation 330).

Next, after obtaining the information about the current position of the object in operation 330, the mobile communication terminal 100 obtains information about the bearing of the object using the bearing calculation unit 140 (operation 340).

In operation 340, the bearing calculation unit 140 may calculate the bearing of the object based on information about the photographing angle of the camera 110 and the information about the current position of the mobile communication terminal 100, which is obtained by the position calculation unit 130 in operation 330.

After obtaining the information about the bearing of the object in operation 340, the mobile communication terminal 100 measures the distance between its current position and the object using the distance measurement unit 150 in operation 350.

In operation 350, the distance measurement unit 150 may measure the distance between the current position of the mobile communication terminal 100 and the object by projecting a beam of light onto the object and receiving the beam of light reflected by the object as described above.

Next, in operation 360, the mobile communication terminal 100 calculates the position of the object based on the information about the current position of the mobile communication terminal 100, which is obtained in operation 330; the information about the bearing of the object, which is obtained in operation 340; and the distance between the current position of the mobile communication terminal 100 and the object, which is measured in operation 350 as described above. Although operations 330, 340, and 350 have been described in a specific order, this order may be modified in any way such that the information determined in operation 330, the information determined in operation 340, and the distance measured in operation 350 are acquired before the calculation is performed in operation 360.

As described above, an object is selected in an image photographed by a camera, information about the current position of a mobile communication terminal, information about the bearing of the object, and information about the distance between the current position of the mobile communication terminal and the object are detected or determined, and the position of the object is calculated based on the information. In this way, information about an object located a distance from the current position of the mobile communication terminal can be obtained using the mobile communication terminal.

The method of obtaining information about an object by using the mobile communication terminal 100 of FIG. 1 may further include operation 370 in which the mobile communication terminal 100 obtains identification information of the object, which corresponds to the position of the object calculated in operation 360, from a map information database.

Here, the map information database may be stored in a built-in memory (not shown) of the mobile communication terminal 100 and may be periodically or non-periodically updated, such as by connecting and downloading the updated information from a server (not shown). Alternatively, the map information database may be received from the server in real-time.

Identification information of an object, which corresponds to position information thereof, is recorded in the map information database of a geographic information system (GIS). In operation 370, the mobile communication terminal 100 retrieves identification information, which corresponds to the position of the object calculated in operation 360, from the map information database and identifies the object based on the retrieved identification information.

The method of obtaining information about an object by using the mobile communication terminal 100 of FIG. 1 may further include operation 380 in which the mobile communication terminal 100 displays the applied information, which corresponds to the identification information obtained in operation 370.

Examples of the applied information include navigation information regarding the object, information about facilities of the object and how to use the facilities, and advertisement information related to the object. Identification information of an object, which corresponds to position information thereof, is stored in the map information database of the GIS. By extension, various applied information may correspond to each piece of identification information.

In operation 380, the mobile communication terminal 100 retrieves applied information, which corresponds to the identification information obtained in operation 370, from the map information database and displays the applied information, which corresponds to the identification information, on the display unit 120. Accordingly, a user can be provided with various applied information.

That is, a user can obtain various applied information about an object located a distance away from the current position of the mobile communication terminal 100 by using the mobile communication terminal 100. For example, the user can obtain navigation information regarding the object, information about facilities of the object and how to use the facilities, or advertisement information related to the object.

As described above, an object is selected in an image photographed by a camera, information about the current position of a mobile communication terminal, information about the bearing of the object, and information about the distance between the current position of the mobile communication terminal and the object are detected or determined, and the position of the object is calculated based on the information. In this way, information about an object located a distance from the current position of the mobile communication terminal can be obtained using the mobile communication terminal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile communication terminal, comprising:
a camera to capture an image;
a display unit to display the image;
a position calculation unit to obtain information about a current position of the mobile communication terminal;
a bearing calculation unit to obtain information about a bearing of an object in the image;
a distance measurement unit to measure a distance between a position of the mobile communication terminal and the object; and
a control unit to select the object and to calculate a position of the object based on the information about the position of the mobile communication terminal, the information about the bearing of the object, and the measured distance between the position of the mobile communication terminal and the object.

2. The mobile communication terminal of claim 1, wherein the distance measurement unit projects a beam of light onto the object and receives the beam of light reflected by the object to measure the distance between the position of the mobile communication terminal and the object.

3. The mobile communication terminal of claim 1, wherein the bearing calculation unit calculates the bearing of the object based on information about a photographing angle of the camera and the information about the position of the mobile communication terminal.

4. The mobile communication terminal of claim 1, wherein the display unit comprises a touch screen, and the control unit selects the object by sensing a touch on the touch screen.

5. The mobile communication terminal of claim 1, wherein the control unit selects the object based on a focal position of the image displayed on the display unit.

6. The mobile communication terminal of claim 1, wherein the control unit obtains identification information of the object, which corresponds to information about the calculated position of the object, from a map information database.

7. The mobile communication terminal of claim 6, wherein the display unit displays applied information, which corresponds to the identification information of the object.

8. The mobile communication terminal of claim 7, wherein the applied information is navigation information regarding the object.

9. The mobile communication terminal of claim 7, wherein the applied information is information about facilities of the object and how to use the facilities.

10. The mobile communication terminal of claim 7, wherein the applied information is advertisement information related to the object.

11. The mobile communication terminal of claim 2, wherein the distance measurement unit rotates to an angle and a bearing which correspond respectively to the information about the photographing angle of the camera and the information about the bearing of the object.

12. The mobile communication terminal of claim 6, wherein the map information database is stored in a memory of the mobile communication terminal and is periodically or non-periodically updated by a server.

13. The mobile communication terminal of claim 6, wherein the map information database is received from a server in real-time.

14. A method of obtaining information about an object using a mobile communication terminal, the method comprising:
displaying an image captured by a camera on a display unit of the mobile communication terminal;
selecting an object in the displayed image;
obtaining information about a position of the mobile communication terminal;
obtaining information about a bearing of the object;
measuring a distance between a position of the mobile communication terminal and the object; and
calculating a position of the object based on the information about the position of the mobile communication terminal, the information about the bearing of the object, and the distance between the position of the mobile communication terminal and the object.

15. The method of claim 14, wherein the measuring of the distance between the position of the mobile communication terminal and the object further comprises: projecting a beam of light onto the object and receiving the beam of light reflected by the object.

16. The method of claim 14, wherein the obtaining of the information about the bearing of the object further comprises: calculating the bearing of the object based on information about a photographing angle of the camera and the information about the position of the mobile communication terminal.

17. The method of claim 14, wherein the selecting of the object further comprises sensing a touch on a touch screen of the mobile communication terminal.

18. The method of claim 14, wherein the selecting of the object further comprises selecting the object based on a focal position of the image displayed on the display unit.

19. The method of claim 14, further comprising obtaining identification information of the object, which corresponds to information about the position of the object, from a map information database.

20. The method of claim 19, further comprising displaying applied information which corresponds to the identification information of the object.

21. The method of claim 20, wherein the applied information is navigation information regarding the object.

22. The method of claim 20, wherein the applied information is information about facilities of the object and how to use the facilities.

23. The method of claim 20, wherein the applied information is advertisement information related to the object.

24. A mobile communication terminal, comprising:
a camera to capture an image including an object;
a display unit to display the image; and
a control unit to select the object and to calculate a position of the object based on information about a position of the mobile communication terminal, information about a bearing of the object, and a distance between the position of the mobile communication terminal and the object.
